(19) United States
(12) Patent Application Publication
(10) Pub. No.: US 2009/0172562 A1
(43) Pub. Date: Jul. 2, 2009

(54) USER INTERFACE DYNAMIC LAYOUT SYSTEM, METHOD FOR ARRANGING USER INTERFACE LAYOUT AND TOUCH CONTROL DISPLAY SYSTEM USING THE SAME

(75) Inventor: Lai-Chen Lai, Taoyuan County (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(73) Assignee: HTC CORPORATION, Taoyuan County (TW)

(21) Appl. No.: 12/344,285

(22) Filed: Dec. 26, 2008

(30) Foreign Application Priority Data
Dec. 28, 2007 (TW) 96151022

(51) Int. Cl. G06F 3/048

(52) U.S. Cl. 715/745

(57) ABSTRACT

A method for arranging a user interface layout is provided. The method is adapted for a touch control display displaying a plurality of icons. Each icon corresponds to a sensing range thereof on the touch control display. The method includes: statistically calculating a utilization frequency of each icon generated by touching the icon on the touch control display; and adjusting the sensing ranges of the icons according to the corresponding utilization frequencies thereof.

### CROSS-REFERENCE TO RELATED APPLICATION

This application claims the priority benefit of Taiwan application serial No. 96151022, filed on Dec. 28, 2007. The entirety of the above-mentioned patent application is hereby incorporated by reference herein and made a part of this specification.

### BACKGROUND OF THE INVENTION

1. Field of the Invention

The present invention generally relates to a system and an operating method of the system, and more particularly, to a user interface dynamic layout system and a method for arranging the user interface layout.

2. Description of Related Art

Recently, catering for the fast pace of modern human beings, portable and space-saving handheld electronic products are being rapidly developed. For example, handheld communication devices, such as PDA cell phones or smart phone, are capable of not only performing all functions of conventional communication devices, but also allowing users to perform additional functions, e.g., editing files, sending/receiving emails, browsing internet, or using instant messengers, via internal built window operation systems. In other words, a user may use such a handheld communication device as a conventional cell phone to dial a phone call, or otherwise as a small PC to use a multiple additional functions. Facilitating with the development of wireless network technology, such handheld communication devices may even provide more convenience to those concerning working efficiency and time management with restriction by time or space.

Window operation systems built in such handheld communication devices usually are succeeded from UIs for ordinary PCs. However, restricted by the sizes of themselves, it is hard to accommodate so many menu icons in a small display, unless using very small icons. Unfortunately, if too small icons are used, when operating the menu to select a desired icon, the user may misselect other adjacent icons and thus entering an undesired frame or performing an unpredicted function. Therefore, the user has to close the entered undesired frame or suspend the performed unpredicted function and return back to the upper level menu, and therefore select the exact desired file or function for performance.

Besides, there are often many icons in a user interface which are rarely used by the user. Presence of such rarely used icons often increases the chance of misselection when the user touch controls the display with a crowd windows frame. As such, the user cannot conveniently and fast operating such a handheld electronic product.

### SUMMARY OF THE INVENTION

Accordingly, the present invention is directed to a method for arranging a user interface layout, which is adapted for providing more convenience for the user.

The present invention is also directed to a user interface dynamic layout system, which is adapted to a frequency of misselecting undesired icons.

The present invention is further directed to a touch control display system, allowing a user to more accurately operate the same.

The present invention provides a method for arranging a user interface layout. The method for arranging a user interface layout is adapted for a touch control display displaying a plurality of icons. Each icon corresponds to a sensing range thereof on the touch control display. The method includes: statistically calculating a utilization frequency of each icon generated by touching the icon on the touch control display; and adjusting the sensing ranges of the icons according to the corresponding utilization frequencies thereof.

According to an embodiment of the method for arranging a user interface layout of the present invention, the step of adjusting the sensing ranges of the icons further includes enlarging a sensing range of an icon having a maximum utilization frequency, so that the icon having the maximum utilization frequency has a largest sensing range comparing with the other icons. The step of adjusting the sensing ranges of the icons further includes adjusting a displaying area of the icon. Further, the icon having the maximum utilization frequency also has the largest displaying area comparing with the other icons.

According to an embodiment of the method for arranging a user interface layout of the present invention, the utilization frequency includes a correct operation frequency, and a misoperation frequency.

According to an embodiment of the method for arranging a user interface layout of the present invention, the step of adjusting the sensing ranges of the icons further includes hiding an icon having a minimum utilization frequency.

According to an embodiment of the method for arranging a user interface layout of the present invention, the step of adjusting the sensing ranges of the icons further includes diminishing a sensing range of an icon having a minimum utilization frequency, so that the icon having the minimum utilization frequency has a smallest sensing range comparing with the other icons.

According to an embodiment of the present invention, the method for arranging a user interface layout further includes statistically calculating the utilization frequency of each icon and adjusting the sensing range thereof at predetermined times according to a time interval setting.

According to an embodiment of the present invention, the method for arranging a user interface layout further includes adjusting an arrangement of each icon in a viewable range of the touch control display according to a corresponding utilization frequency of each icon, so as to arrange the icon having the maximum utilization frequency at a top position of the viewable range.

The present invention further provides a user interface dynamic layout system. The user interface dynamic layout system is adapted for a touch control display displaying a plurality of icons. Each icon corresponds to a sensing range thereof on the touch control display. The user interface dynamic layout system includes a utilization frequency counting module, and a range adjusting module. The utilization frequency counting module is adapted for statistically calculating a utilization frequency of each icon generated by touching the icon on the touch control display. The range adjusting module is adapted for adjusting the sensing ranges of the icons according to the corresponding utilization frequencies thereof. The range adjusting module is further adapted to enlarge a sensing range of an icon having a maximum utilization frequency, so that the icon has a largest sensing range comparing with the other icons. The range adjusting module further includes a displaying area adjusting module, adapted for adjusting a displaying area of an icon. Further, the displaying area adjusting module adjusts the icon having the maximum utilization frequency so that the icon having the maximum utilization frequency has the largest displaying area comparing with the other icons.

According to an embodiment of the user interface dynamic layout system of the present invention, the utilization frequency includes a correct operation frequency, and a misoperation frequency.

According to an embodiment of the user interface dynamic layout system of the present invention, the range adjusting module hides an icon having a minimum utilization frequency.

According to an embodiment of the user interface dynamic layout system of the present invention, the range adjusting module diminishes a sensing range of an icon having a minimum utilization frequency, so that the icon having the minimum utilization frequency has a smallest sensing range comparing with the other icons.

According to an embodiment of the present invention, the user interface dynamic layout system further includes a time interval setting module, for statistically calculating the utilization frequency of each icon and adjusting the sensing range thereof at predetermined times.

According to an embodiment of the present invention, the user interface dynamic layout system further includes an icon arrangement adjusting module, for adjusting an arrangement of each icon in a viewable range of the touch control display according to the corresponding utilization frequency of each icon, so as to arrange the icon having the maximum utilization frequency at a top position of the viewable range.

The present invention further provides a method for arranging a user interface layout, adapted for a touch control display displaying a plurality of icons. Each icon corresponds to a sensing range thereof on the touch control display. The method includes: statistically calculating a utilization frequency of each icon generated by touching the icon on the touch control display; and adjusting a status of the icon according to the corresponding utilization frequency thereof.

According to an embodiment of the method for arranging a user interface layout of the present invention, the status includes a displaying area of the icon. The step of adjusting a status of the icon further includes enlarging a displaying area of an icon having a maximum utilization frequency. The icon having the maximum utilization frequency has a largest displaying area comparing with the other icons. Further, the step of adjusting a status of the icon further includes diminishing a displaying area of an icon having a minimum utilization frequency, so that the icon having the minimum utilization frequency has a smallest displaying area comparing with the other icons. Furthermore, the method for arranging a user interface layout according to the embodiment of the present invention further includes statistically calculating the utilization frequency of each icon and adjusting the displaying area thereof at predetermined times according to a time interval setting.

According to an embodiment of the method for arranging a user interface layout of the present invention, the utilization frequency includes a correct operation frequency, and a misoperation frequency.

According to an embodiment of the method for arranging a user interface layout of the present invention, the step of adjusting the status of the icon further includes hiding an icon having a minimum utilization frequency.

According to an embodiment of the present invention, the method for arranging a user interface layout further includes adjusting an arrangement of each icon in a viewable range of the touch control display according to a corresponding utilization frequency of each icon, so as to arrange the icon having the maximum utilization frequency at a top position of the viewable range.

According to an embodiment of the method for arranging a user interface layout of the present invention, the step of adjusting a status of the icon includes adjusting displaying brightness of the icon.

The present invention further provides a touch control display system. The touch control display system includes a touch control sensing unit, a display unit, and a control unit. The display unit is adapted for displaying a plurality of icons, each corresponding to a sensing range on the touch control sensing unit. The control unit is adapted for statistically calculating a utilization frequency of each icon generated by touching the icon on the touch control display, and adjusting the sensing ranges of the icons according to the corresponding utilization frequencies thereof.

According to an embodiment of the touch control display system of the present invention, the control unit is adapted for enlarging a sensing range of an icon having a maximum utilization frequency, so that the icon having the maximum utilization frequency has a largest sensing range comparing with the other icons. The step of adjusting the sensing ranges of the icons further includes adjusting a displaying area of the icon. Further, the icon having the maximum utilization frequency also has the largest displaying area comparing with the other icons.

According to an embodiment of the touch control display system of the present invention, the utilization frequency includes a correct operation frequency, and a misoperation frequency.

According to an embodiment of the touch control display system of the present invention, the control unit is adapted for hiding an icon having a minimum utilization frequency.

According to an embodiment of the touch control display system of the present invention, the control unit is adapted for diminishing a sensing range of an icon having a minimum utilization frequency, so that the icon having the minimum utilization frequency has a smallest sensing range comparing with the other icons.

According to an embodiment of the touch control display system of the present invention, the control unit is adapted for statistically calculating the utilization frequency of each icon and adjusting the sensing range thereof at predetermined times according to a time interval setting.

The present invention further provides a touch control display system, including a touch control sensing unit, a display unit and a control unit. The display unit is adapted for displaying a plurality of icons, each corresponding to a sensing range on the touch control sensing unit. The control unit is adapted for statistically calculating a utilization frequency of each icon generated by touching the icon on the touch control display, and adjusting a status of the icon according to the corresponding utilization frequency thereof.

According to an embodiment of the touch control display system of the present invention, the status includes a displaying brightness of the icon.

According to an embodiment of the touch control display system of the present invention, the status includes a displaying area of the icon. The control unit is adapted for diminishing a displaying area of an icon having a minimum utilization frequency, so that the icon having the minimum utilization frequency has a smallest displaying area comparing with the other icons. Furthermore, the control unit is adapted for statistically calculating the utilization frequency of each icon and adjusting the displaying area thereof at predetermined times according to a time interval setting. The control unit is further adapted for enlarging a displaying area of an icon having a maximum utilization frequency. The icon having the maximum utilization frequency has a largest displaying area comparing with the other icons.

According to an embodiment of the touch control display system of the present invention, the utilization frequency includes a correct operation frequency, and a misoperation frequency.

According to an embodiment of the touch control display system of the present invention, the control unit is adapted for hiding an icon having a minimum utilization frequency.

According to an embodiment of the touch control display system of the present invention, the control unit is adapted for adjusting an arrangement of each icon in a viewable range of the touch control display according to a corresponding utilization frequency of each icon, so as to arrange the icon having the maximum utilization frequency at a top position of the viewable range.

In the present invention, displaying statuses, e.g., sensing range, displaying area, or displaying brightness, of the most frequently touched icons or icons which often cause misselections are adjusted according to an statistic of a corresponding utilization frequency of each icon of the touch control display, thus strengthening vision effects of the icons or enlarging the sensing ranges thereof. In such a way, a possibility of misselecting undesired icons when the user touches the icons can be lowered.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is schematic flow chart illustrating a method for arranging a user interface layout according to an embodiment of the present invention.

FIGS. 2A to 2B are schematic top views illustrating a method for arranging a user interface layout according to an embodiment of the present invention.

FIG. 2C illustrates an arranging order of icons displayed in a display for the method for arranging a user interface layout according to an embodiment of the present invention.

FIG. 3 is a schematic diagram illustrating a touch control display system according to an embodiment of the present invention.

FIG. 4 is a schematic diagram illustrating a user interface dynamic layout system according to an embodiment of the present invention.

### DESCRIPTION OF THE EMBODIMENTS

Reference will now be made in detail to the present preferred embodiments of the invention, examples of which are illustrated in the accompanying drawings. Wherever possible, the same reference numbers are used in the drawings and the description to refer to the same or like parts.

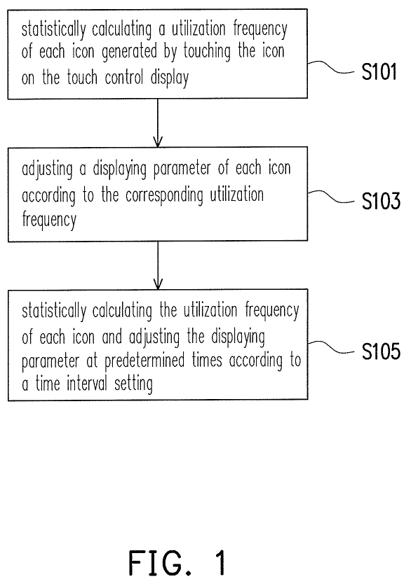

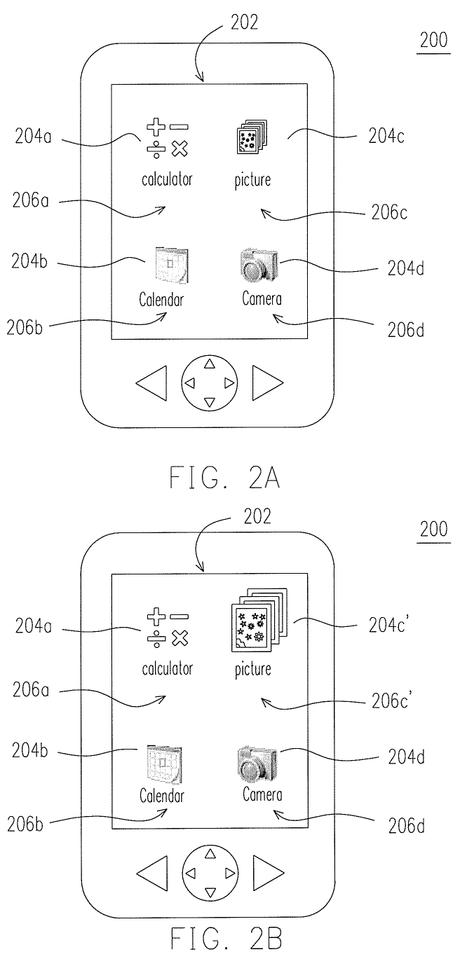

FIG. 1 is schematic flow chart illustrating a method for arranging a user interface layout according to an embodiment of the present invention. FIGS. 2A to 2B are schematic top views illustrating a method for arranging a user interface layout according to an embodiment of the present invention. Referring to FIGS. 1 and 2A, a portable electronic product 200 includes a touch control display 202 having a plurality of icons 204a, 204b, 204c, and 204d displayed thereon. At a step S101, a utilization frequency of each of the icons 204a, 204b, 204c, and 204d generated by touching the icon on the touch control display is statistically calculated. Then, at a step S103, a displaying parameter is adjusted according to a corresponding utilization frequency to each of the icons 204a, 204b, 204c, and 204d. The displaying parameter includes sensing ranges 206a, 206b, 206c and 206d, or a status of the icon (displaying status). The status of the icon includes a displaying area of the icon or a displaying brightness of the icon. Further, according to an aspect of the invention, the utilization frequency includes a correct operation frequency, and a misoperation frequency. The correct operation frequency is a frequency that the user correctly operates the desired icon, while the misoperation frequency is a frequency that the user practically touches other icons rather than the desired one.

According to an embodiment of the present invention, if the displaying parameter is the sensing ranges of the icons, the step S103 includes adjusting, e.g., enlarging, a sensing range of an icon having a maximum utilization frequency, so that the icon having the maximum utilization frequency has a largest sensing range, i.e., the sensing range 206c′ as shown in FIG. 2B, comparing with the other icons. According to another aspect of the embodiment, the step of adjusting the sensing ranges of the icons further includes hiding an icon having a minimum utilization frequency. Further, the step of adjusting the sensing ranges of the icons further includes diminishing a sensing range of an icon having a minimum utilization frequency, so that the icon having the minimum utilization frequency has a smallest sensing range comparing with the other icons.

According to an embodiment of the present invention, if the displaying parameter is the displaying status, e.g., a displaying area, of each icon, the step S103 includes adjusting a displaying status of an icon having a maximum utilization frequency, e.g., enlarging a displaying area of the icon having the maximum utilization frequency, so that the icon having the maximum utilization frequency has a largest displaying area, i.e., the icon 204c′ as shown in FIG. 2B, comparing with the other icons. Further, according to another aspect of the embodiment, the step of adjusting a displaying status of the icons for example includes hiding an icon having the minimum utilization frequency. According to another aspect of the embodiment, the step of adjusting a displaying status of the icons for example includes diminishing a displaying area of the icon having the minimum utilization frequency, so that the icon having the minimum utilization frequency has a smallest displaying area comparing with the other icons. Further, according to an aspect of the previous embodiment, the step of adjusting the sensing ranges of the icons further includes simultaneously adjusting displaying areas of the icons, so that the icon having the maximum utilization frequency has the largest displaying area comparing with the other icons. Likewise, according to an aspect of the above latter embodiment, the step of adjusting displaying areas of the icons further includes simultaneously adjusting the sensing ranges of the icons.

Besides the adjusting a displaying parameter of the icon according to a corresponding utilization frequency, the step S103 further includes adjusting an arrangement of each icon in a viewable range of the touch control display according to a corresponding utilization frequency of each icon, so as to arrange the icon having the maximum utilization frequency at a top position of the viewable range which ranked the number one among all icons. For example, the icon having the maximum utilization frequency at a top position in a viewable range of the display with the icons displayed in a up-down order, e.g., icon 208 as shown in FIG. 2C.

According to an embodiment of the present invention, the method for arranging a user interface layout further includes a step S105 succeeded the step S103. The step S105 includes statistically calculating the corresponding utilization frequency of each icon and adjusting the corresponding displaying parameter, e.g., the sensing range or the displaying status, thereof, at predetermined times according to a time interval setting.

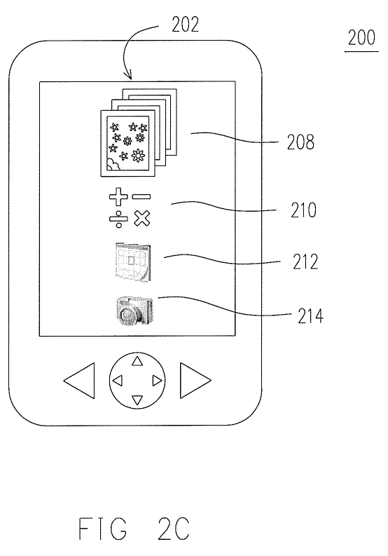

FIG. 3 is a schematic diagram illustrating a touch control display system according to an embodiment of the present invention. Referring to FIG. 3, there is shown a touch control display system 300 including a touch control sensing unit 302, a display unit 304, and a control unit 306. The display unit 304 is adapted for displaying a plurality of icons, e.g., the icons 204a, 204b, 204c and 204d of FIG. 2, each corresponding to a sensing range, e.g., the sensing ranges 206a, 206b, 206c and 206d of FIG. 2, on the touch control sensing unit 302. The control unit 306 is adapted for statistically calculating a utilization frequency of each icon generated by touching a sensing range of an icon via the touch control sensing unit 302, and adjusting a displaying parameter of the icons according to the corresponding utilization frequencies thereof. The displaying parameter for example includes a displaying area of the icon or a displaying brightness of the icon. According to an embodiment of the touch control display system of the present invention, the utilization frequency includes a correct operation frequency, and a misoperation frequency.

The process of the control unit 306 adjusting the displaying parameter of the icons for example includes enlarging a sensing range or a displaying area of the icon having the maximum utilization frequency, so that the icon having the maximum utilization frequency has a largest sensing range or displaying area, i.e., the sensing range 206′ or the displaying area 204′ as shown in FIG. 2B. Further, when adjusting the sensing range of the icon, the displaying area of the icon can be adjusted at the same time.

Further, the step of adjusting the displaying parameter of the icon further includes hiding the icon having the minimum utilization frequency. According to another embodiment, the step of adjusting the displaying parameter, e.g., the sensing range or the displaying area of the icon further includes diminishing the sensing range or the displaying area of the icon having the minimum utilization frequency, so that the icon having the minimum utilization frequency has a smallest sensing range or displaying area comparing with the other icons.

The control unit 306 is further adapted for statistically calculating the utilization frequency of each icon and adjusting the corresponding displaying parameter (including the sensing range or the displaying area) of the icon at predetermined times according to a time interval setting. Further, the control unit 306 is also adapted for adjusting an arrangement of each icon in a viewable range of the touch control display 202 according to a corresponding utilization frequency of each icon, so as to arrange the icon having the maximum utilization frequency at a top position with a first order of the viewable range.

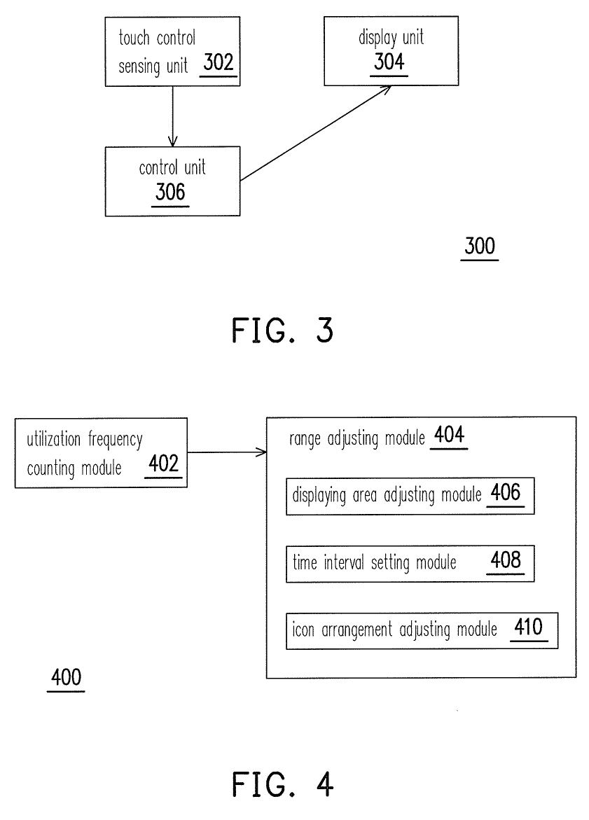

FIG. 4 is a schematic diagram illustrating a user interface dynamic layout system according to an embodiment of the present invention. Referring to FIG. 4, the above control unit 306 is also named as a user interface dynamic layout system 400. The user interface dynamic layout system 400 includes a utilization frequency counting module 402, and a range adjusting module 404. The utilization frequency counting module 402 is adapted for statistically calculating a utilization frequency of each icon generated by touching the icon via the touch control display 202 of FIG. 2A. The utilization frequency includes a correct operation frequency, and a misoperation frequency. The range adjusting module 404 is adapted for adjusting the sensing ranges of the icons according to the corresponding utilization frequencies thereof. The range adjusting module 404 is further adapted to enlarge a sensing range of an icon having a maximum utilization frequency, so that the icon has a largest sensing range comparing with the other icons.

The range adjusting module 404 is capable of adjusting a displaying area of an icon while adjusting a sensing range of the icon. In other words, the range adjusting module 404 further includes a displaying area adjusting module 406, adapted for adjusting a displaying area of an icon. Further, the displaying area adjusting module 406 adjusts the icon having the maximum utilization frequency so that the icon having the maximum utilization frequency has the largest displaying area comparing with the other icons. The range adjusting module 404 is adapted to hide the icon having the minimum utilization frequency. The range adjusting module 404 is also adapted to diminish the icon having the minimum utilization frequency, so that the icon having the minimum utilization frequency has the smallest sensing range.

According to another aspect of the embodiment, the user interface dynamic layout system 400 further includes a time interval setting module 408, for statistically calculating the utilization frequency of each icon and adjusting the corresponding sensing range or displaying area at predetermined times. According to a further aspect of the embodiment, the user interface dynamic layout system 400 further includes an icon arrangement adjusting module 410, for adjusting an arrangement of each icon in a viewable range of the touch control display according to the corresponding utilization frequency of each icon, so as to arrange the icon having the maximum utilization frequency at a top position corresponding to the first order of the icons of the viewable range, i.e., the icon 208 as shown in FIG. 2C.

In the present invention, displaying statuses, e.g., sensing range, displaying area, or displaying brightness, of the most frequently touched icons or icons which often cause misselections are adjusted according to an statistic of a corresponding utilization frequency of each icon of the touch control display 202, thus strengthening vision effects of the icons or enlarging the sensing ranges thereof by adjusting a displaying status of the icons, e.g., sensing range, displaying area, and displaying brightness. In such a way, a possibility of misselecting undesired icons when the user touches the icons can be lowered. Further, in a set time interval, dynamically adjusting icons in a viewable range of the display according to the corresponding utilization frequency obtained of each icon is helpful to improve the convenience and accuracy for the user to touch control the icons.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A method for arranging a user interface layout, adapted for a touch control display displaying a plurality of icons, each icon corresponding to a sensing range on the touch control display, the method comprising:
statistically calculating a utilization frequency of each icon generated by touching the icon on the touch control display; and
adjusting the sensing ranges of the icons according to the corresponding utilization frequencies.

2. The method for arranging a user interface layout according to claim 1, wherein the step of adjusting the sensing ranges of the icons further comprises enlarging a sensing range of an icon having a maximum utilization frequency, so that the icon having the maximum utilization frequency has a largest sensing range comparing with the other icons.

3. The method for arranging a user interface layout according to claim 2, wherein the step of adjusting the sensing ranges of the icons further comprises adjusting a displaying area of the icon.

4. The method for arranging a user interface layout according to claim 1, wherein the utilization frequency comprises a correct operation frequency, and a misoperation frequency.

5. The method for arranging a user interface layout according to claim 1 further comprising adjusting an arrangement of each icon in a viewable range of the touch control display according to a corresponding utilization frequency of each icon, so as to arrange the icon having the maximum utilization frequency at a top position of the viewable range.

6. A user interface dynamic layout system, adapted for a touch control display displaying a plurality of icons, each icon corresponding to a sensing range on the touch control display, the user interface dynamic layout system comprising:
a utilization frequency counting module, adapted for statistically calculating a utilization frequency of each icon generated by touching the icon on the touch control display; and
a range adjusting module, adapted for adjusting the sensing ranges of the icons according to the corresponding utilization frequencies.

7. The user interface dynamic layout system according to claim 6, wherein the range adjusting module is further adapted to enlarge a sensing range of an icon having a maximum utilization frequency, so that the icon has a largest sensing range comparing with the other icons.

8. The user interface dynamic layout system according to claim 6, wherein the range adjusting module comprises a displaying area adjusting module, adapted for adjusting a displaying area of an icon.

9. The user interface dynamic layout system according to claim 8, wherein the displaying area adjusting module adjusts the icon having the maximum utilization frequency so that the icon having the maximum utilization frequency has the largest displaying area comparing with the other icons.

10. The user interface dynamic layout system according to claim 6, wherein the utilization frequency comprises a correct operation frequency, and a misoperation frequency.

11. The user interface dynamic layout system according to claim 6 further comprising an icon arrangement adjusting module, for adjusting an arrangement of each icon in a viewable range of the touch control display according to the corresponding utilization frequency of each icon, so as to arrange the icon having the maximum utilization frequency at a top position of the viewable range.

12. A method for arranging a user interface layout, adapted for a touch control display displaying a plurality of icons, each icon corresponding to a sensing range on the touch control display, the method comprising:
statistically calculating a utilization frequency of each icon generated by touching the icon on the touch control display; and
adjusting a status of the icon according to the corresponding utilization frequency.

13. The method for arranging a user interface layout according to claim 12, wherein the status comprises a displaying area of the icon.

14. The method for arranging a user interface layout according to claim 13, wherein the step of adjusting a status of the icon further comprises enlarging a displaying area of an icon having a maximum utilization frequency.

15. The method for arranging a user interface layout according to claim 12, wherein the utilization frequency comprises a correct operation frequency, and a misoperation frequency.

16. The method for arranging a user interface layout according to claim 12, wherein the step of adjusting a status of the icon comprises adjusting displaying brightness of the icon.

17. A touch control display system, comprising:
a touch control sensing unit,
a display unit, adapted for displaying a plurality of icons, each corresponding to a sensing range on the touch control sensing unit; and
a control unit, adapted for statistically calculating a utilization frequency of each icon generated by touching the icon on the touch control display, and adjusting the sensing ranges of the icons according to the corresponding utilization frequencies.

18. The touch control display system according claim 17, wherein the control unit is adapted for enlarging a sensing range of an icon having a maximum utilization frequency, so that the icon having the maximum utilization frequency has a largest sensing range comparing with the other icons.

19. A touch control display system, comprising:
a touch control sensing unit,
a display unit, adapted for displaying a plurality of icons, each corresponding to a sensing range on the touch control sensing unit; and
a control unit, adapted for statistically calculating a utilization frequency of each icon generated by touching the icon on the touch control display, and adjusting a status of the icon according to the corresponding utilization frequency.

20. The touch control display system according claim 19, wherein the status comprises a displaying brightness of the icon.

21. The touch control display system according claim 19, wherein the status comprises a displaying area of the icon.
